(19) United States
(12) Patent Application Publication
(10) Pub. No.: US 2014/0335919 A1
(43) Pub. Date: Nov. 13, 2014

(54) ELECTRONIC CHARGING DEVICE

(71) Applicants: Brian N. Stewart, Indianapolis, IN (US); Brian William Shield, Indianapolis, IN (US)

(72) Inventors: Brian N. Stewart, Indianapolis, IN (US); Brian William Shield, Indianapolis, IN (US)

(21) Appl. No.: 14/099,952

(22) Filed: Dec. 7, 2013

Related U.S. Application Data
(63) Continuation-in-part of application No. 13/891,817, filed on May 10, 2013.

(51) Int. Cl. H02J 7/00

(52) U.S. Cl. CPC H02J 7/0042; H02J 2007/0062
USPC 455/573; 320/107; 320/111; 320/137; 713/300

(57) ABSTRACT

An apparatus for providing electrical power, including an electrically non-conductive generally cube-shaped housing, an electrical power supply operationally connected and positioned in the housing, a first plurality of power outlets electrically connected to power supply for connecting three-prong plugs, a second plurality of power outlets for connecting male USB connectors, and a power cord operationally connected to the power.

### CROSS-REFERENCE TO RELATED APPLICATIONS

This patent application claims priority to co-pending U.S. patent application Ser. No. 13/891,817 filed on May 10, 2013.

### TECHNICAL FIELD

The present novel technology relates generally to the field of electrical devices, and, more particularly, to a desktop power supply and charging station.

### BACKGROUND

In a hyper-connected world, technology and portable electronic devices continue to change the way we work, play, and communicate. The internet has evolved from being a “nice-to-have” luxury to a channel for growth and innovation that transcends almost every facet of life; everyone and everything simply is online, whether at school, at the office, or on-the-go. A market-research company has stated that the average U.S. internet household now has 5.7 internet-connected devices, and the number of electronic devices around the globe is expected to hit anywhere from fifty billion to a staggering one trillion in the next five years. As the facts allude, most individuals today now own more than one portable electronic device, whether it be a cell phone, mp3 player, tablet, or laptop.

Portable electronic devices typically depend upon batteries as a power source, and most devices are rechargeable through an AC (alternating current) power cord, or a USB (universal serial bus) interface. The range of portable electronic devices on the market is diverse, and the AC power cords or USB power cords that permit recharging of said devices are rarely transitional amongst the varying devices. It is not atypical for an individual to charge multiple portable electronic devices at once, with multiple power cords. With various ways, and cords, to power portable electronic devices, multiple AC power receptacles or USB ports are needed to charge several devices at once. Often times, power outlets are scarce or are inconveniently placed out of reach from a desk or table-like structure where most electronics are placed or used.

While a variety of power strips that turn one AC wall receptacle into several are known, there is currently a need for a portable electronic device that solves several issues unaddressed by the traditional power strip. Power strips are often bulky in their traditionally elongated rectangular form, making portability inconvenient. Further, the use of a power strip typically requires one to reach down to the floor to find an available plug or power source, and often times individuals must rest their portable electronic devices on or near the floor due to the traditionally short AC power cords needed to power a portable electronic device. Similarly, the use of a USB outlet to power a portable electronic device typically requires a personal computer to act as the host controller; personal computers are often located underneath a desk or on the floor, and also tend to have short power cords.

In addition, most portable electronic devices on the market today draw the charging current they need up to the charging current that the charger can provide, if the charger conforms to the brand's requirements. The vast majority of charging devices can't determine the charger capabilities or simply aren't sophisticated enough, and will default and blindly pull 0.1 to 0.5a @ 5 v. Furthermore, devices today that feature multiple USB ports to allow charging of numerous devices at once generally contain only one PC board that forces multiple devices to share amps between the devices charging. By forcing a power struggle amongst multiple devices, charging to full capacity generally takes longer and generally shortens the life of the battery while negatively impacting the device.

Currently, individuals are not able to charge multiple portable electronic devices at once through a device that is located on a desk or tabletop, nor are they typically able to use the devices as the batteries recharge due to the location of AC power wall outlets and traditional power strips. Furthermore, individuals are unable to utilize a charging device that allows independent device negotiation specific to manufacturer specification, while also isolating each device from others plugged into the USB ports.

There is a need for an improved electronic power supply and charging device that can provide power to multiple AC powered devices, and multiple USB powered devices at once, without the “on the floor” cord dilemma, and without the power struggle amongst the devices being charged. The present novel technology addresses this need.

### BRIEF DESCRIPTION OF THE DRAWINGS

FIG. 1 is a front perspective view of an electronic charging device according to a first embodiment of the present novel technology.

FIG. 2 is a front perspective view of a third embodiment illustrating a removable plastic cover.

FIG. 3 is a rear plan view of a second embodiment electronic charging device illustrating an attached AC plug and a third embodiment of the present novel technology illustrating a removable plastic cover.

FIG. 4 is an exploded view of the embodiment of FIG. 1 is a front perspective view of a third embodiment illustrating a removable plastic cover.

FIG. 5 is a front perspective view of a third embodiment illustrating a removable plastic cover.

FIG. 6 is a custom power conversion board.

FIG. 7 is a front perspective view of a fourth embodiment electronic charging device.

FIG. 8 is a top plan view of FIG. 6, illustrating a fourth embodiment electronic charging device.

FIG. 9 is a front perspective view of a fifth embodiment electronic charging device.

FIG. 10 is a side perspective view of a sixth embodiment electronic charging device.

FIG. 11 is a top plan view of a second embodiment custom power conversion board.

FIG. 12 is a top plan view of the bottom of a second embodiment custom power conversion board.

FIG. 13 is a top perspective view of a seventh embodiment electronic charging device.

### DESCRIPTION OF THE PREFERRED EMBODIMENTS

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

As used herein, the phrase “personal electronic device”, “electronic device”, “protocoled device”, or “electronic charging device” is a portable digital device such as a mobile phone, a personal digital assistant, a hand-held entertainment device, a handheld PC, a pad or tablet computer system or a set top box.

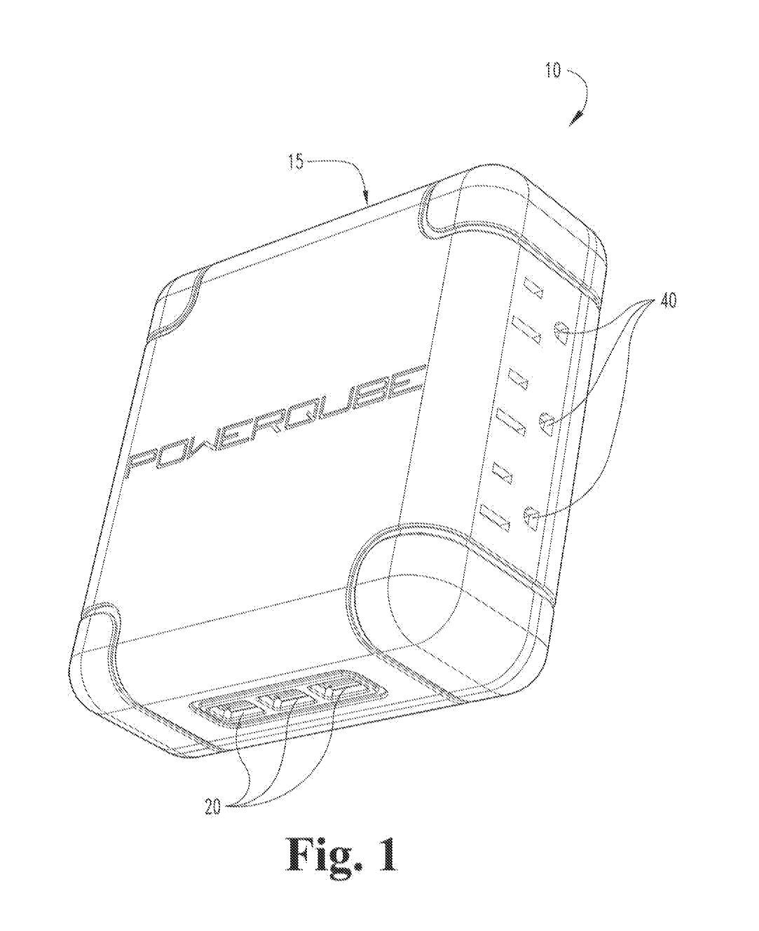

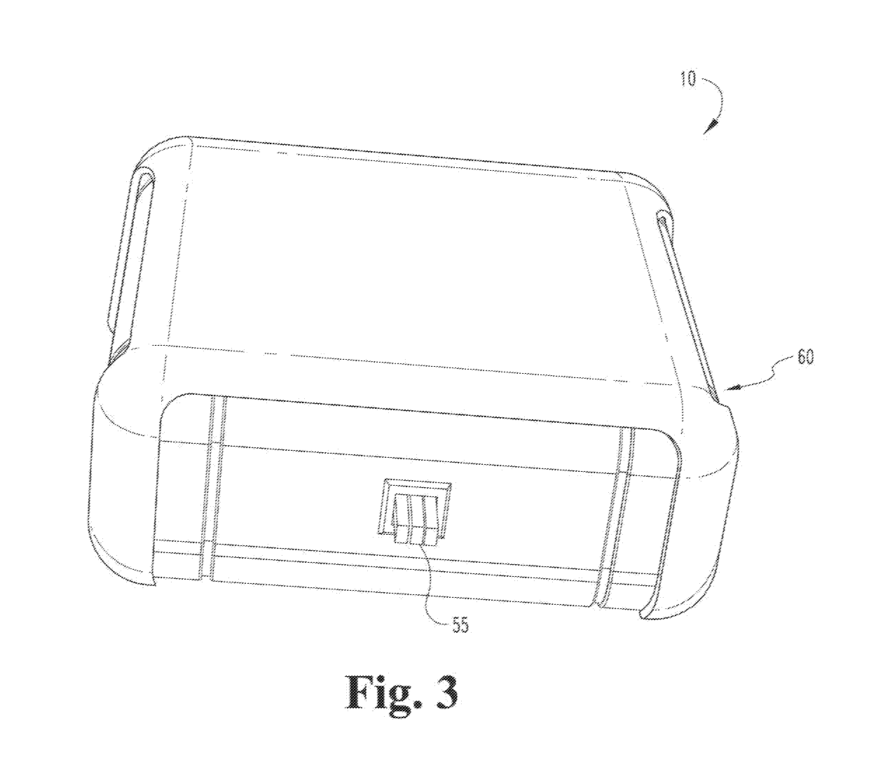

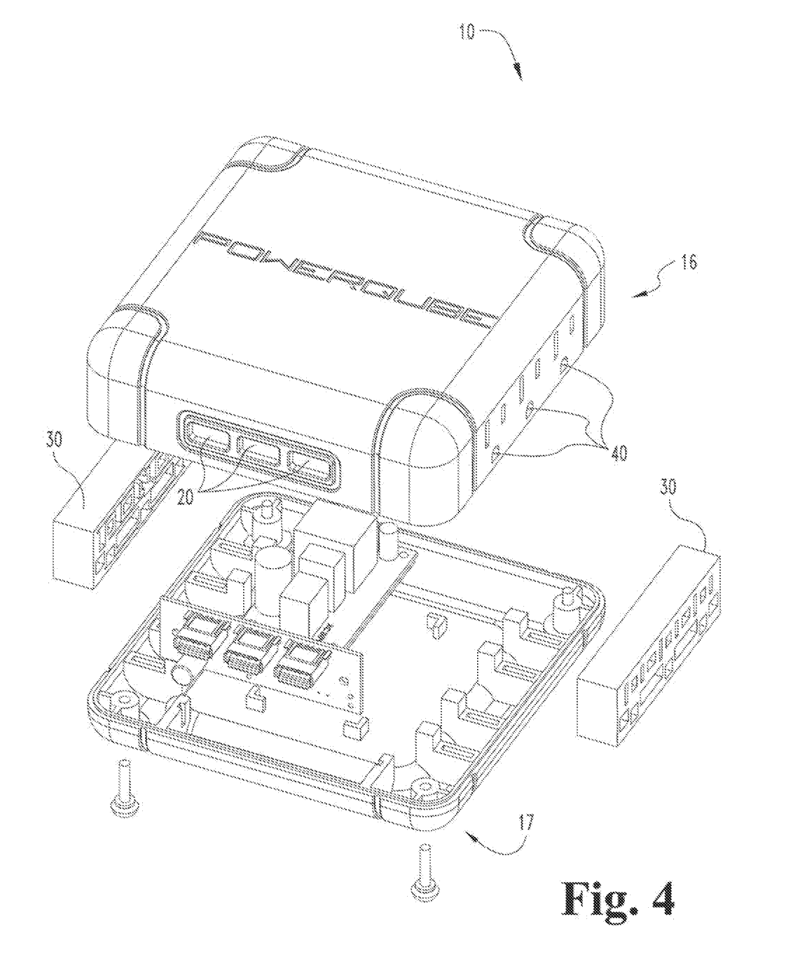

FIGS. 1-4 illustrate a first embodiment of the present novel technology, a generally cube-shaped electronic power supply and charging device 10 for providing power to other electrical devices having standard two or three-pronged plugs as well as to USB devices. The electronic charging device 10 includes a housing 15 which is customarily defined by a base portion 16 and engageable cover portion 17. The housing 15 is typically made of hard, electrically non-conducting plastic or the like, although any convenient material may be selected. The housing 15 encases a custom power supply 18 that is operationally connected to a likewise encased custom power conversion board 19 for providing power to a plurality (typically three) of three-pronged electrical outlets 40 positioned on one or more cube faces and to a plurality (typically three) of USB ports 20 positioned on one or more cube faces. The electronic charging device 10 is typically compact, more typically measuring about 4.5 inches by about 2.75 inches, such that the device 15 is portable; for example, the device can easily fit into a backpack, travel bag, briefcase, or the like for travel. Alternatively, the electronic charging device 10 may embody varying sizes.

The electronic charging device 10 typically includes an AC power cord 55 extending from the housing 15 for connecting the custom power supply 18 in electric communication with a primary single-phase AC power supply in a home or office through a standard three-prong male AC plug 29 located at the distal end thereof. In some embodiments, the AC power cord 55 is connected in electric communication with the custom power supply 18, while in other embodiments the AC power cord 55 terminates in an electrical connector that is attachable to an electrical connector positioned in the housing 15 and connected in electric communication with the custom power supply 18. The AC power cord may be extendable and retractable, so as to be stored within the housing 15 when not in use. When engaged with an AC power outlet, the AC power cord 55 provides standard household electrical power to the custom power supply 18, typically ranging between 110 and 240 volts, alternating current with a frequency between 50 and 60 Hz. In some embodiments, the custom power supply 18 has a mode allowing for a quick charge with increased input and output, providing for a total power of 20 W.

The system includes over voltage protection, short circuit protection, and over current protection to prevent electrical surges; with increased protection for the quick charge embodiment. Further, the custom power supply 18 provides for automatic recovery after a short-circuit fault is removed and automatic shutdown when over voltage protection is activated.

The electronic charging device 10 includes a plurality of three-pronged receptacles 30 disposed in the housing 15, each receptacle 30 operationally connected to a respective connector outlet or port 40 positioned on one or more sides of the cover 17. The electrical outlets 40 are connected in electric communication with the power supply 18 and receive AC power of the same voltage and frequency as supplied by to the AC power cord 55.

The custom power supply 18 further functions as a transformer and rectifier, for converting AC input to lower voltage DC output. The custom conversion board 19 is operationally connected to the custom power supply 18 to receive transformed and rectified DC power, typically 5 Volts and 2.5 Amps. When in the quick charge mode discussed above, the custom conversion board 19 is operationally connected to the custom power supply 18 to receive transformed and rectified DC power, typically 5 Volts and 4 Amps.

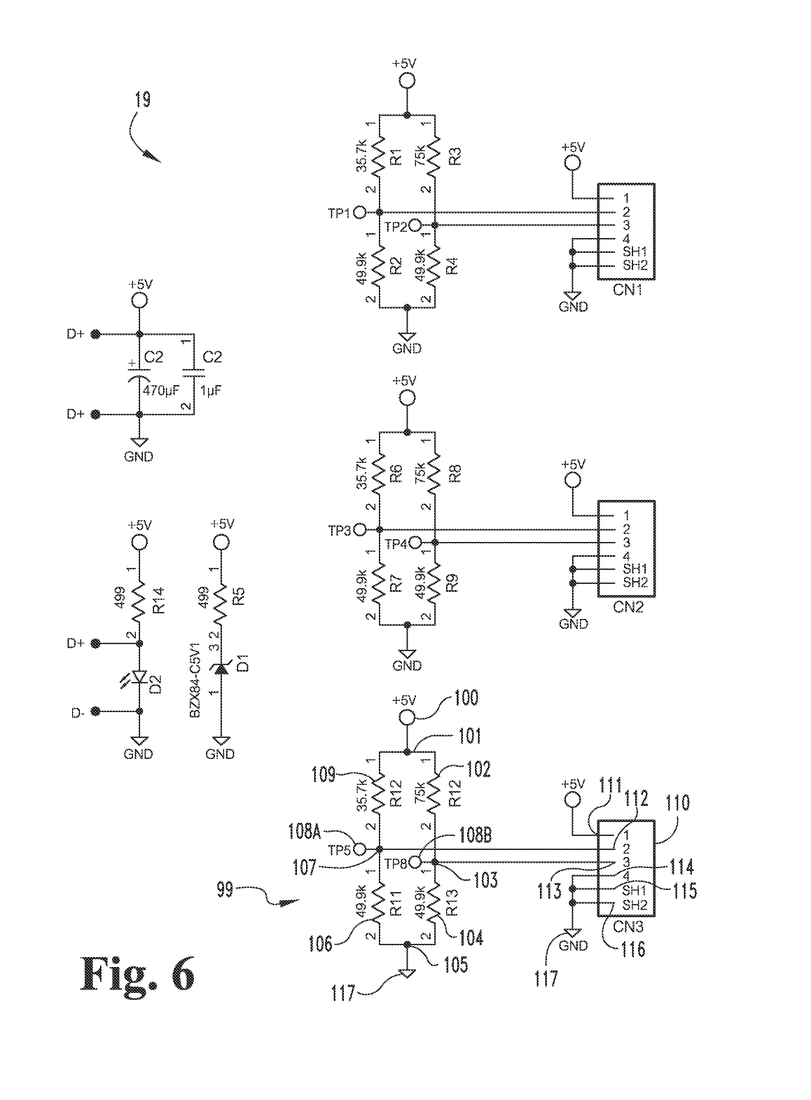

The custom conversion board 19 is illustrated in greater detail in FIG. 6. The board 19 contains one or more USB power supply circuits 99. Each circuit 99 includes a voltage source 100 electrically connected to first node 101. The voltage source 100 is typically the transformed and rectified 5V DC output from the power supply 18. First resistor 102 is electrically connected between first node 101 and second node 103. Second resistor 104 is electrically connected between second node 103 and third node 105. Third resistor 106 is electrically connected between third node 105 and fourth node 107. First test point (TP) 108A is electrically connected to Fourth node 107. Fourth resistor 109 is electrically connected between first node 101 and fourth node 107. Second test point 108B is electrically connected to second node 103. USB connector 110 includes six pins 111-116, with first pin 111 electrically connected to the voltage source 100, second pin 112 electrically connected to fourth node 109, third pin 113 electrically connected to second node 103, and fourth, fifth and sixth pins 114-116 electrically connected to ground 117, as is third node 105. A USB male connector is engagable with chip 110 to receive power therefrom.

In one embodiment, the first resistor 102 has a resistance of about 75K Ohms, the second resistor 104 has a resistance of about 50K Ohms, the third resistor 106 has a resistance of about 50K Ohms, and the fourth resistor 109 has a resistance of about 38K Ohms.

In operation, the electronic charging device 10 provides for a plurality (typically three) of USB ports 20 positioned on one or more housing 15 faces for supplying DC power to USB devices. A USB male connector is engaged with a port 20 and is subsequently supplied with (typically) 5V DC power. Likewise, a standard 2-prong or 3-prong plug may be engaged with a port 40 to receive (typically) 110V AC power. In some embodiments, the custom power supply may include transformer functionality to step the input voltage up or down, for instance providing an AC output voltage from 110V or 220V or higher, and a DC output voltage from 1.5V, 2.5V, or 4.0V or the like, to accommodate the voltage requirements of different devices and/or regionally common line voltages and frequencies.

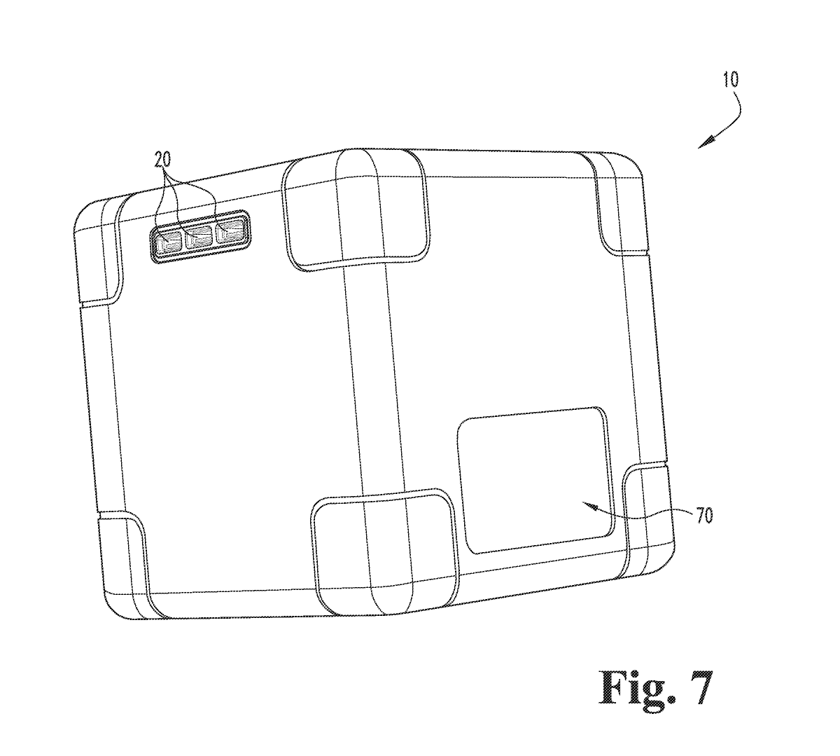

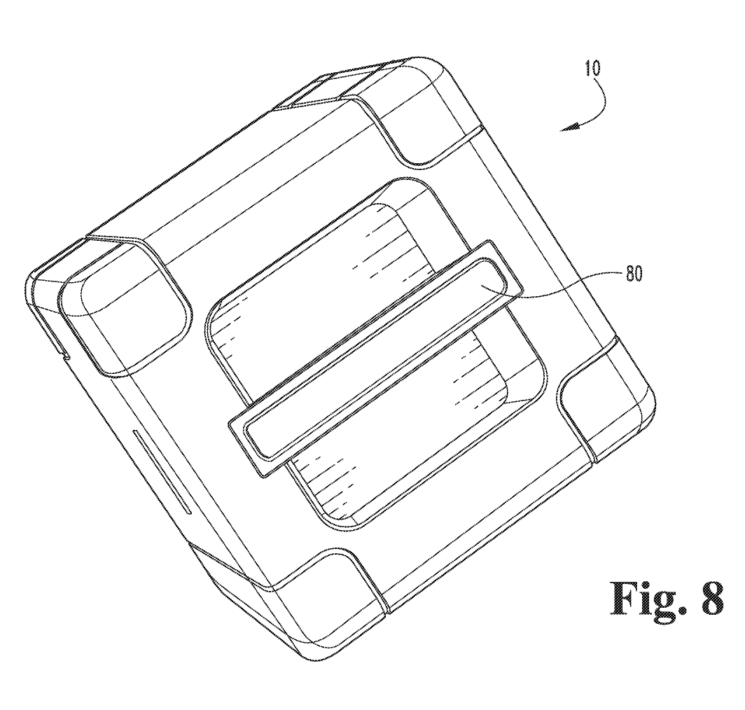

In another embodiment, the electronic charging device 10 operates as described above, however, the location of the connection for the standard two or three-prong AC power cord is not directly on the device 10 itself. As shown in FIG. 7, opposite the AC power cord 55 is an aperture 70 that houses an extension cord (not shown) that extends from the electronic charging device 10 to provide power to more remote devices. The extension cord (not shown) provides for a plurality of AC receptacles (not shown) to allow multiple devices to be plugged into the electronic charging device 10 simultaneously. A plurality (typically three) USB ports 20 remain on one or more housing faces. This embodiment further provides a handle 80, typically made of hard electrically non-conducting plastic or the like, although any convenient composition may be selected, that is located on the top plan view of the embodiment, as illustrated in FIG. 8. The handle 80 may be recessed when not in use and extendable for use, or may be formed having a fixed position.

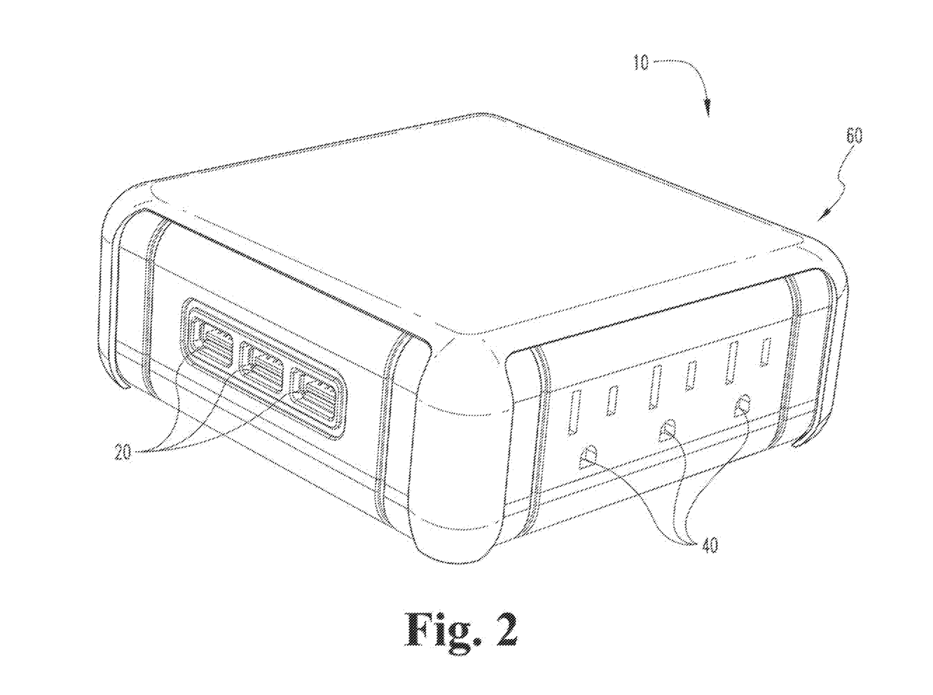

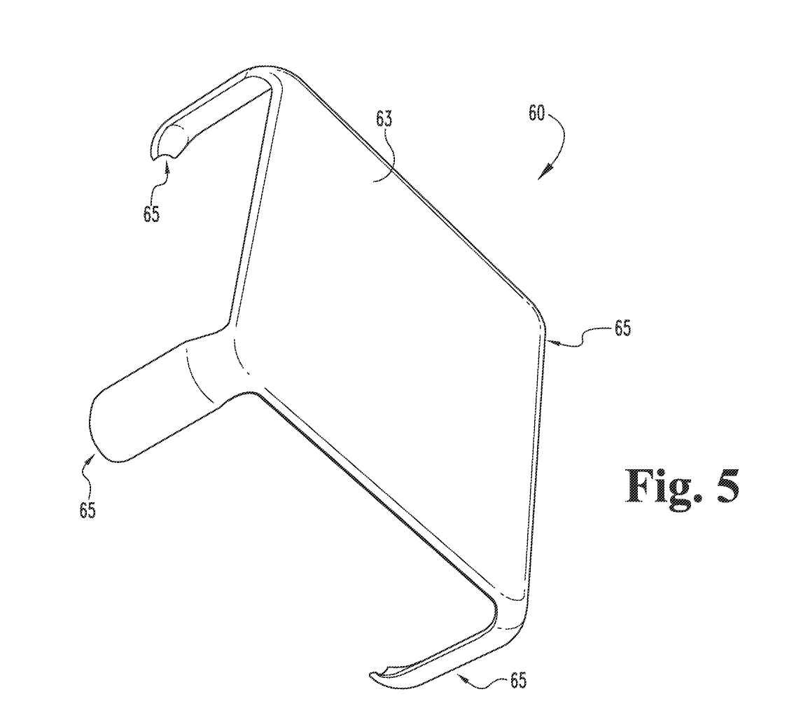

As seen in FIGS. 2-3 and FIG. 5, a removable cover 60 may be engaged to protect and compliment the device 10. The cover 60 typically includes surface ornamentation. The removable cover 60 is typically made of semi-pliable electrically non-conducting plastic or the like, although any convenient composition may be selected. The cover 60 typically features a generally elongated top surface that snugly fits the dimensions of the present novel technology. The removable cover 60 includes a generally rectangular flat portion 63 and four leg members 65 extending perpendicularly or downwardly from each of the respective four corners to securely connect the cover to the top of the electronic charging device 10 as illustrated in FIGS. 2-3 and 5. The leg members 65 typically engage the sides of the device housing 15 in a snug interference fit.

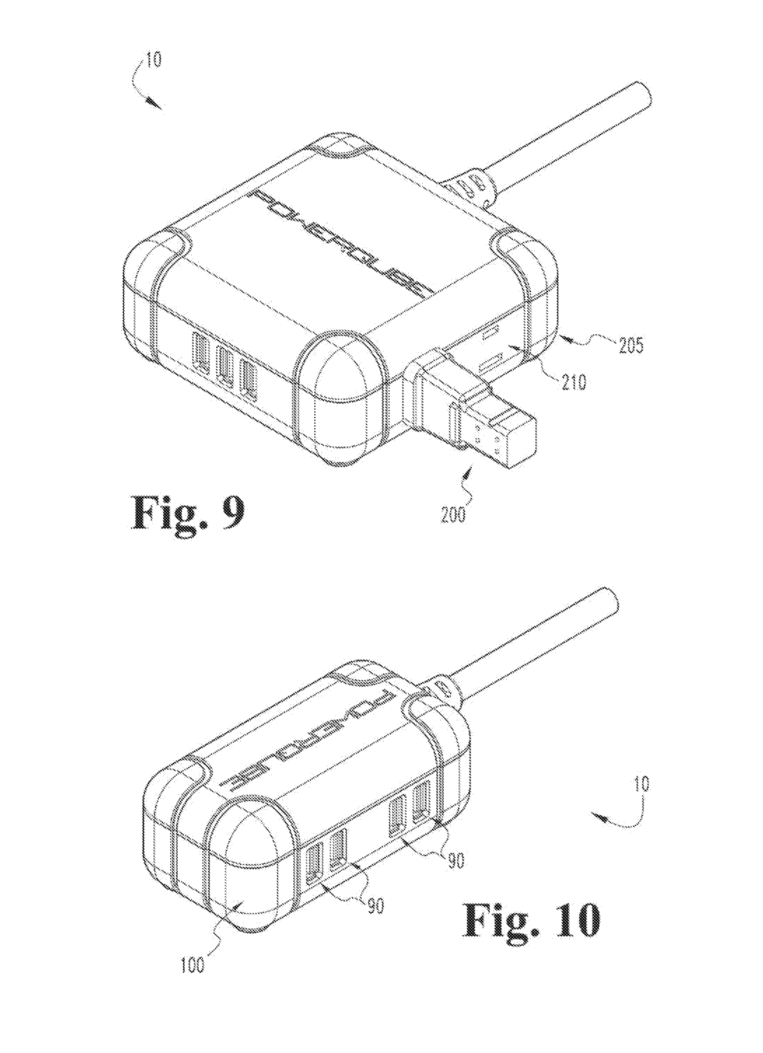

In one alternative embodiment, as illustrated in FIG. 9, the electronic charging device 10′ is configured to operate much as described above, but with the outlets 210 disposed in the housing 205 for supplying AC power including a plurality of typically two-pronged receptacles 210. In addition, the device 10′ includes a removable adapter 200, designed to mate with an international male plus. Further, electronic charging device 10′ is able to generate a variety of voltage and power outputs and accommodate a variety of voltage and power inputs so that the electronic charging device 10′ may be utilized both in the United States and abroad. The removable international adapter 200 typically extends from the housing 205 for connecting the custom power supply 18 in electronic communication with a device featuring an international AC plug.

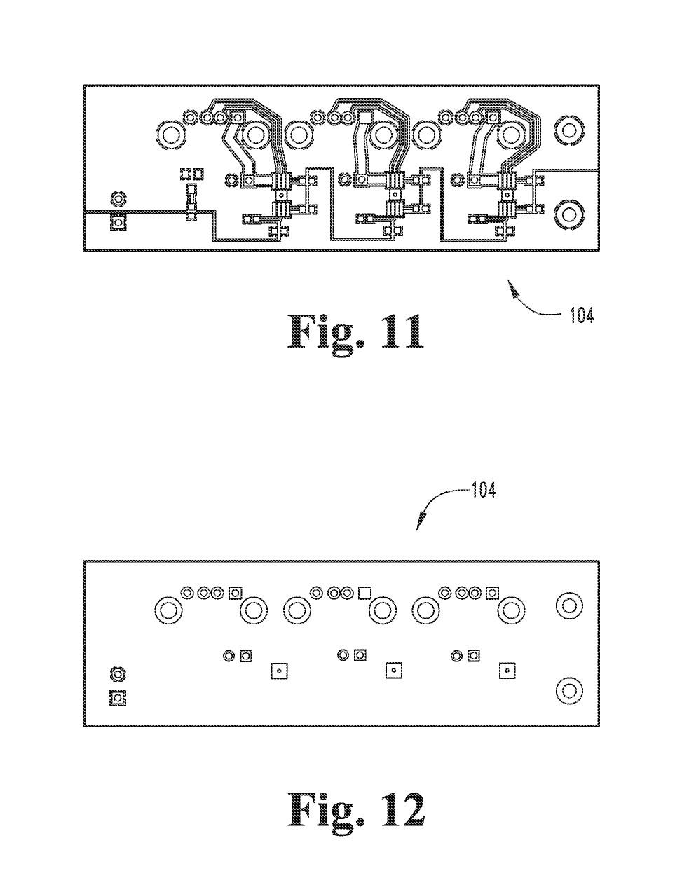

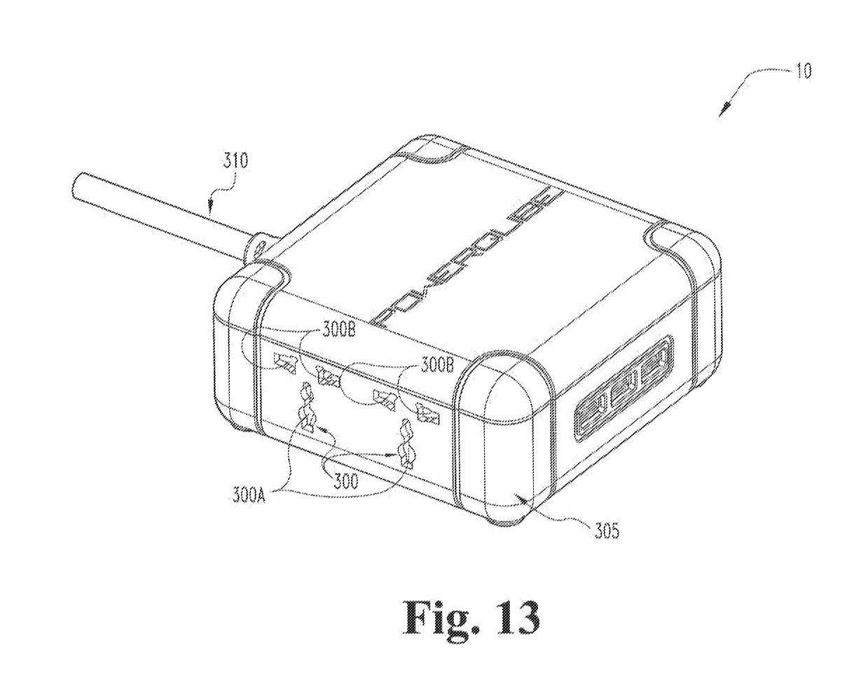

In another alternate embodiment, as illustrated in FIGS. 10, 11, and 12, the system 10″ functions similarly to the above-described embodiment 10, but with a few differences. In this embodiment, the electronic charging device 10″ is typically smaller and more compact, more typically measuring about 2.5 inches by about 2.0 inches, such that the device 10″ is portable and can easily fit into a backpack, handbag, or the like for travel. Alternately, the electronic charging device 10″ may be configured to varying sizes. The electronic charging device 10″ typically does not include a plurality of three-pronged receptacles 30 disposed in the housing 15 as illustrated above regarding the first embodiment 10″, but instead the housing 100 typically contains a plurality (more typically, eight) of USB ports 90 positioned on one or more housing 100 faces for supplying DC power to USB devices. While the custom conversion board or control circuit 19 described above remains functionally similar or the same, the system 10″ includes a reconfigured board layout 104 as illustrated in FIGS. 11 and 12, allowing each protocoled device in electric communication with a USB charging port 90 to operate independently from one another. In other words, each USB port 90 functionally contains its own power supply, and is typically configured to supply typically between 1 ampere to about 5 amperes and typically between around 1 volt and around 5 volts (more typically around 1.5A at 5V), generally providing constant and isolated power as requested by a connected device. The reconfigured board 104 permits each USB charging port 90 to independently negotiate power requirements with a specific device that is engaged, typically permitting each device connected to a USB port 90 to charge at its preferred amperage rate and speed, while also providing a “quick charge” option. By isolating each device independently, devices plugged into the electronic charging device 10″ are not forced to compete over amps and/or voltages in a power struggle while charging. Furthermore, the board 104 allows the USB port 90 to more slowly charge at the preferred manufacturer's rate when full charging capacity is approached, and to stop charging completely once the device is fully charged.

The board 104 is typically configured to provide power to a respective USB port 90 sequentially in a number of predetermined pin configurations, each respective configuration having the charging protocols for a predetermined type of protocolled device, such as an IPHONE, IPAD (IPHONE and IPAD are registered trademarks of Apple. Inc., 1 Infinite Loop, Cupertino, Calif. 95014), ANDROID smartphone (ANDROID is a registered trademark of Google, Inc., 1600 Amphitheatre Parkway, Mountain View Calif. 94043), or the like.

The board 104 will cycle through predetermined charging protocols until the device connected thereto through a USB port 90 begins to draw power at which time the board 104 will cease cycling and maintain the configuration compatible with the device. In some embodiments, the board 104 and the device connected thereto via the USB port 90 functionally communicate with, or query, each other to establish the requisite charging protocols be established at the USB port 90.

In another embodiment, the electronic charging device 10′″ operates much as described above regarding the first embodiment 10; however, the plurality of three-pronged receptacles 30 generally disposed in the housing 305 are designed and shaped to accept AC plugs from a variety of countries, such as a NEMA-1 plug, a NEMA 5-15 plug, a CEE 7/16 Europlug, or the like. The plurality of international AC receptacles 300, typically positioned on one or more sides of the housing 15, typically features a male two-round prong plug input 300A as well as a female universal receptacle output 300B and are operationally connected to a respective connector outlet or port (not shown) located within the housing 305. The international AC receptacles 300 are connected in electric communication with the power supply 18 and receive AC power of the same voltage and frequency as supplied by the AC power cord 310 as adapted to the differing international civil voltage.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1) A electrical charging system, comprising:
an electrical power source;
a plurality of power outlets in electric communication with the power source;
wherein at least two respective power outlets are USB ports;
wherein each respective USB port is independently configurable to receive a respective electronic device having a respective predetermined charging protocol;
wherein each respective USB port is configurable to charge a respective electronic device at an optimal rate, as determined by the charging protocol requirements of the respective electronic device.

2) The system of claim 1 wherein at least one respective power outlet is configured to engage an NEMA-1 plug, in electric communication.

3) The system of claim 1 wherein at least one respective power outlet is configured to engage an NEMA 5-15 plug, in electric communication.

4) The system of claim 1 wherein at least one respective power outlet is configured to engage a USB connector, in electric communication.

5) The system of claim 1 wherein at least one respective power outlet is configured to engage a CEE 7/16 Europlug.

6) The system of claim 1 further comprising an adapter to fit a CEE 7/16 Europlug into a NEMA 1 or NEMA 5-15 outlet.

7) The system of claim 1 wherein each respective USB port ceases supplying power once the electronic device been charged to capacity.

8) The system of claim 1 wherein the electronic device is a smartphone.

9) The system of claim 1 wherein the electronic device is a tablet.

10) A regulation device for optimizing the charging of a battery, comprising:
a power supply connectable in electronic communication with an electric power source;
a plurality of USB ports operationally connected to the power supply:
a control circuit operationally connected to the power supply and operationally connected to each respective USB port;
wherein the control circuit engages in electric communication with a protocoled device operationally connected to a respective USB port; and
wherein the control circuit configures the respective USB to provide power output compatible with the protocoled device operationally connected thereto.

11) The device of claim 10 wherein the protocoled device is a smartphone.

12) The device of claim 10 wherein the device is a tablet.

13) The device of claim 10 wherein the current supplied to the protocoled device by each respective USB port is between about 1 ampere to about 5 amperes.

14) The device of claim 10 further comprising a NEMA-1 outlet operationally connected to the power supply.

15) The device of claim 10 further comprising a NEMA 5-15 plug operationally connected to the power supply.

16) The device of claim 10 wherein each respective USB port supplies an electric potential to each respective protocoled device of between about 1 volt and 5 volts.

17) A method for charging a protocoled device battery comprising:
a) providing a power supply;
b) operationally connecting a protocoled device into a receiving power outlet;
wherein the receiving power outlet is operationally connected to a control circuit;
wherein the control circuit and receiving power outlet are in electric communication with the power supply;
c) querying the control circuit; and
d) configuring the receiving power outlet to provide power to charge the protocoled device.

18) The method of claim 17 wherein the receiving power outlet is a USB port.

19) The method of claim 17 wherein the protocol device is a handheld PC.
